(19) United States
(12) Patent Application Publication
(10) Pub. No.: US 2003/0025671 A1
(43) Pub. Date: Feb. 6, 2003

(54) Optical mouse with a roller ball

(76) Inventor: Yu-Chih Cheng, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,725

(22) Filed: Feb. 7, 2002

(30) Foreign Application Priority Data
Aug. 2, 2001 (TW) 090118937

(51) Int. Cl. G09G 5/08

(52) U.S. Cl. 345/163

(57) ABSTRACT

An optical mouse has a housing, a roller ball, a light source, and control circuitry. The housing has a flat bottom surface and a first opening on the bottom surface. The roller ball is rotatably disposed inside the housing. The light source is disposed inside the housing for generating light to illuminate the roller ball. The control circuitry is disposed inside the housing for controlling operations of the optical mouse. The control circuitry has a light sensor for detecting variations of light reflected from the roller ball.

### BACKGROUND OF INVENTION

1. Field of the Invention

The present invention relates to an optical mouse, and more specifically, to an optical mouse with a roller ball.

2. Description of the Prior Art

Please refer to FIG. 1. FIG. 1 is a diagram of a traditional mechanical mouse 10 according to the prior art. The traditional mechanical mouse 10 uses a ball disposed within a housing of the mouse 10, and which is in contact with a surface. As the mechanical mouse 10 is moved across the surface, the ball rolls and causes two rotatable axes to be rotated. The mouse 10 further comprises two sensors for detecting rotational conditions of the two axes and transforming the conditions into two corresponding pointing signals. This design has been in wide use for many years, and is still quite popular today. Unfortunately, the rolling ball tends to pick up dirt. This dirt builds up on the two rotatable axes and affects the quality of contact between the ball and the rotatable axes. The dirt build up causes the motion of the mouse 10 to be abnormal. For normal operation, the mouse 10 needs to be regularly cleaned.

Optical mice were introduced to overcome this problem. An optical mouse determines its direction and distance of motion according to variations of reflected light, and then generates corresponding pointing signals.

Please refer to FIG. 2. FIG. 2 is a bottom perspective view of a prior art optical mouse 20. As shown in FIG. 2, the optical mouse 20 has a bottom surface 22 with an opening 24 located on the bottom surface 22. It is through the opening 24 that the optical mouse 20 can scan an external plane on which the optical mouse 20 slides. Displacement information is sent to a computer (not shown) by way of a cable 25. The cable 25 may end in one of many standard adapters, such as a communication adapter, a PS/2 adapter, a universal serial bus (USB) adapter, etc.

Please refer to FIG. 3. FIG. 3 is an exploded diagram of the prior art optical mouse 20. The optical mouse 20 further comprises an optical module 30 disposed on an upper side of the opening 24, a circuit board 40 disposed above the optical module 30, a light sensor 42 disposed above the circuit board 40, a light-emitting diode (LED) 44 disposed above the circuit board 40, and a light shield 46 also disposed above the circuit board 40. The light sensor 42 is used to examine the external surface on which the optical mouse 20 slides for analyzing and determining the displacements of the optical mouse 20. The LED 44 is used to function as a light source of the light sensor 42. The light shield 46 is used to prevent unwanted light from the LED 44 from inadvertently reaching the light sensor 42. The optical module 30 comprises a lens 32, a first reflective surface 34, and a second reflective surface 36. The circuit board 40 has a hole 48 located above the lens 32, and the light sensor 42 is disposed above the hole 48 of the circuit board 40. The first reflective surface 34 protrudes through the hole 48 so that the first reflective surface 34 is between the LED 44 and the light sensor 42.

Please refer to FIG. 4 with reference to FIG. 3. FIG. 4 is a highly simplified side view of the optical mouse 20 depicted in FIG. 3. As shown in FIG. 4, the LED 44 generating light 27 faces towards the first reflective surface 34. The shape of the light shield 46 is designed to prevent unwanted light 27 from the LED 44 from inadvertently reaching the light sensor 42. As a result, the majority of the light 27 travels to the first reflective surface 34, from which the light 27 is then reflected down to the second reflective surface 36. From the second reflective surface 36, the light 27 is reflected through the opening 24 of the bottom surface 22 to illuminate a surface 26. Light 28 is reflected, and hence modulated, by the surface 26 and is gathered and concentrated by the lens 32 to be focused onto the light sensor 42. The light sensor 42 uses variations in the reflected light 28 to determine the direction and magnitude of motion of the optical mouse 20.

The optical mouse 20 solves the problem of poor operation of the mechanical mouse 10 due to accumulation of dirt and dust. Nevertheless, when the surface 26 that the optical mouse 20 rests on is made of glass or a particular color of material, light 28 reflected from the surface 26 cannot be focused entirely onto the light sensor 42. Thus, the light sensor 42 cannot take repetitive pictures of the surface 26, which causes the optical mouse 20 to generate erroneous pointing signals.

### SUMMARY OF INVENTION

It is therefore a primary objective of the claimed invention to provide an optical mouse with a roller ball, which is capable of operating on any flat surface.

The claimed invention discloses an optical mouse with a roller ball. The optical mouse has a housing, a roller ball, a light source, and control circuitry. The housing has a flat bottom surface and a first opening on the bottom surface. The roller ball is rotatably disposed inside the housing. The light source is disposed inside the housing for generating light to illuminate the roller ball. The control circuitry is disposed inside the housing for controlling operations of the optical mouse, and the control circuitry has a light sensor for detecting variations of light reflected from the roller ball.

It is an advantage of the claimed invention that the optical mouse has a roller ball, therefore, light generated from the light source does not reflect from the external surface through the first opening of the bottom surface. Instead, light is illuminated directly onto the roller ball, thus overcoming the design limitations of the prior art optical mouse.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a traditional mechanical mouse according to the prior art.

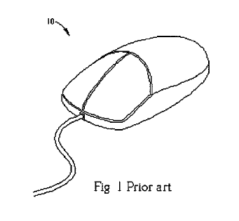

FIG. 2 is a bottom perspective view of a prior art optical mouse.

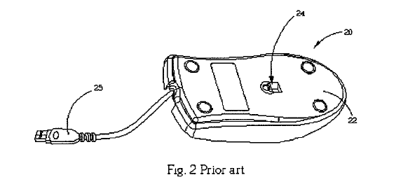

FIG. 3 is an exploded diagram of the prior art optical mouse.

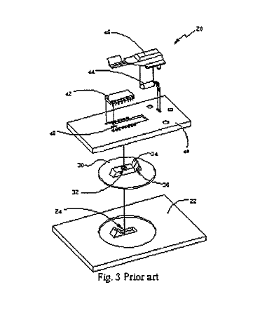

FIG. 4 is a highly simplified side view of the optical mouse depicted in FIG. 3.

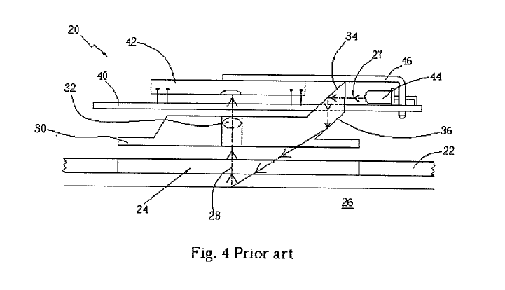

FIG. 5 is a diagram of an optical mouse when used by a user according to the present invention.

FIG. 6 is a bottom perspective view of the optical mouse depicted in FIG. 5.

FIG. 7 is an exploded diagram of the optical mouse depicted in FIG. 5.

FIG. 8 is a diagram of internal components of the optical mouse depicted in FIG. 5 after being fabricated.

FIG. 9 is a highly simplified side view of the optical mouse depicted in FIG. 5.

### DETAILED DESCRIPTION

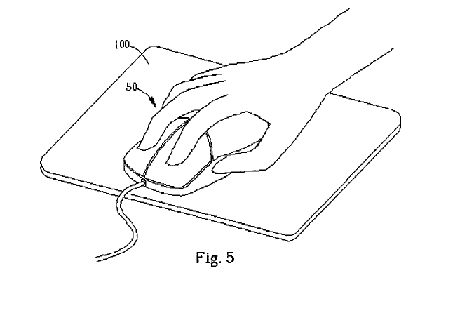

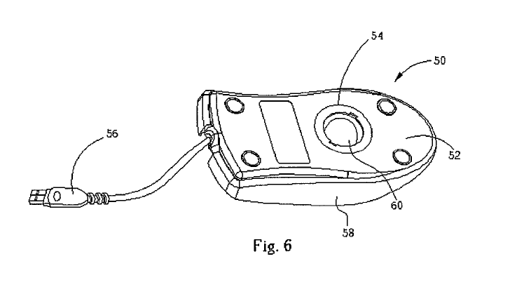

Please refer to FIG. 5 and FIG. 6. FIG. 5 is a diagram of an optical mouse 50 when used by a user according to the present invention. FIG. 6 is a bottom perspective view of the optical mouse 50 depicted in FIG. 5. The optical mouse 50 is designed to be slidely operated by a user on an external plane 100. The optical mouse comprises a housing 58 and a roller ball 60. The housing 58 has a flat bottom surface 52 and a first opening 54 on the bottom surface 52, and the roller ball 60 is contact with the external plane 100 through the first opening 54. It is through rotation of the roller ball 60 that the optical mouse 50 detects the displacement and direction of the optical mouse 50 sliding on the external plane 100. Information on displacement and direction is sent to a computer (not shown) by way of a cable 56. The cable 56 may end in one of many standard adapters, such as a communication adapter, a PS/2 adapter, a universal serial bus (USB) adapter, etc.

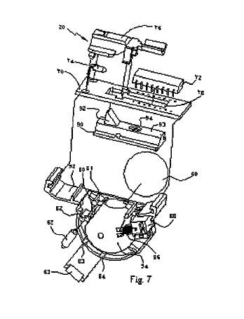

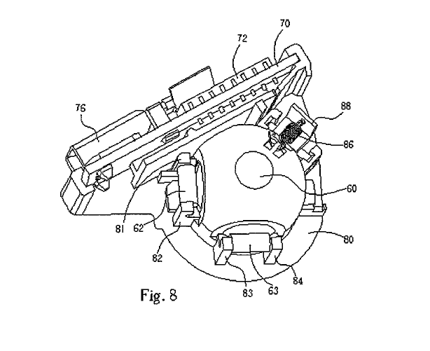

Please refer to FIG. 7 and FIG. 8. FIG. 7 is an exploded diagram of the optical mouse 50 depicted in FIG. 5. FIG. 8 is a diagram of internal components of the optical mouse 50 depicted in FIG. 5 after being fabricated. The optical mouse 50 further comprises an elastic device 86, two roller wheels 62 and 63, a light source 74 disposed inside the housing 58, a control circuit board 70 disposed above the flat bottom surface 52, an optical device 90, and a light shield 76 disposed above the control circuit board 70. The light source 74 is an LED for generating light to illuminate the roller ball 60. The control circuit board 70 comprises control circuitry (not shown) for controlling operations of the optical mouse 50 and a light sensor 72 disposed above the control circuit board 70 for detecting variations of light reflected from the roller ball 60. The control circuit board 70 has a second opening 78 for passing the light reflected from the roller ball 60 to the light sensor 72. The optical device 90 is disposed between the roller ball 60 and the control circuit board 70 above the flat bottom surface 52 for alternating an optical path of the light generated by the light source 74. Additionally, the optical device 90 further comprises a first lens 92 fixed on a lens base 93 for projecting the light generated by the light source 74 onto the roller ball 60, and a second lens 94 mounted within the second opening 78 of the control circuit board 70 for projecting the light reflected off the roller ball 60 to the light sensor 72. The light shield 76 is used to prevent unwanted light from the light source 74 from inadvertently reaching the light sensor 72. Moreover, the flat bottom surface 52 further comprises four L-type positioning bases 81, 82, 83 and 84, a global shell 80, and a base 88. The L-type positioning bases 81, 82 and the L-type positioning bases 83, 84 are respectively used to fix the roller wheels 62 and 63. The roller wheels 62 and 63 will be rotated by engaging with the roller ball 60, and the roller ball 60 can smoothly rotate on the external plane 100. The global shell 80 is monolithically formed with the flat bottom surface 52 so that the roller ball is exactly mounted within the global shell 80 to maintain operations of the optical mouse 50. The elastic device 86 disposed on the base 88 comprises a spring for producing elasticity to elastically push the roller ball 60 against the roller wheels 62 and 63.

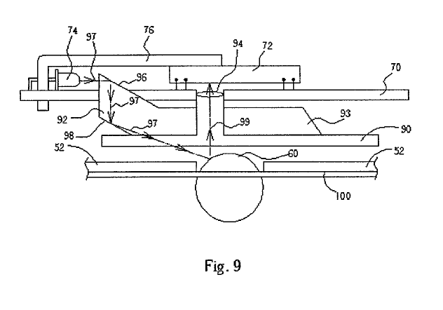

Please refer to FIG. 9. FIG. 9 is a highly simplified side view of the optical mouse 50 depicted in FIG. 5. When a user moves the housing 58 against the external surface 100, the roller ball 60 will be rotated by engaging with the external surface 100 at the first opening 54 and the control circuitry of the control circuit board 70 generates corresponding pointing signals by detecting variations of light received by the light sensor 72. Furthermore, the roller ball 60 has a graphed surface or a rough surface so that the light received by the light sensor 72 has different intensities.

Light 97 is generated by the light source 74. The light shield 76 blocks some of the light 97, but the majority of the light 97 is emitted in the direction of a first reflective surface 96 of the first lens 92. The majority of the light 97 travels to the first reflective surface 96 of the first lens 92, from which the light 97 is then reflected down to a second reflective surface 98 of the first lens 92. From the second reflective surface 98, the light 97 is reflected through the optical device 90 to illuminate a surface of the roller ball 60. The roller ball 60 is made of opaque materials, so the light 97 illuminating the roller ball 60 will be turned into reflection light 99 via total reflection or partial reflection. The reflection light 99 is reflected, and hence modulated, by the surface of the roller ball 60. The reflection light 99 is then gathered and concentrated by the second lens 94 to be focused onto the light sensor 72. The light sensor 72 uses variations of the reflection light 99 to determine the direction magnitude of motion of the optical mouse 50.

In contrast to the prior art, the present invention optical mouse 50 has a roller ball 60. The light 97 generated from the light source 74 does not illuminate the external surface 100 through the first opening 54 of the bottom surface 52. Instead, the light 97 directly illuminates the roller ball 60, thus improving upon the design limitations of the prior art optical mouse.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An optical mouse comprising:
a housing having a flat bottom surface and a first opening on the bottom surface;
a roller ball rotatably disposed inside the housing;
a light source disposed inside the housing for generating light to illuminate the roller ball;
a light sensor disposed inside the housing for receiving light reflected from the roller ball; and
control circuitry disposed inside the housing for controlling operations of the optical mouse;
wherein when a user moves the housing against a flat surface, the roller ball will be rotated by engaging with the flat surface and the control circuitry is capable of generating corresponding pointing signals by detecting variations of light received by the light sensor.

2. The optical mouse of claim 1 further comprising an optical device for alternating an optical path of the light generated by the light source.

3. The optical mouse of claim 2 wherein the optical device comprises a first lens set for projecting the light generated by the light source onto the roller ball.

4. The optical mouse of claim 2 wherein the optical device comprises a second lens set for projecting the light reflected from the roller ball to the light sensor.

5. The optical mouse of claim 1 wherein the control circuitry is disposed on a circuit board, the circuit board having a second opening for passing the light reflected from the roller ball to the light sensor.

6. The optical mouse of claim 1 further comprising an elastic device and at least one roller wheel, wherein the elastic device elastically pushes the roller ball against the roller wheel.

7. The optical mouse of claim 6 comprising two roller wheels which are pushed by the roller ball when the roller ball is pushed by the elastic device.

8. The optical mouse of claim 1 wherein the roller ball has a graphed surface so that the light received by the light sensor has different intensities.

9. The optical mouse of claim 1 wherein the roller ball has a rough surface so that the light received by the light sensor has different intensities.
